(19) United States
(12) Patent Application Publication
(10) Pub. No.: US 2017/0039325 A1
(43) Pub. Date: Feb. 9, 2017

(54) COMMUNITY REFERRAL CLUSTER TECHNOLOGY PLATFORM

(71) Applicants: Thomas Christopher Dorsett, Austin, TX (US); Tushar Jain, Austin, TX (US)

(72) Inventors: Thomas Christopher Dorsett, Austin, TX (US); Tushar Jain, Austin, TX (US)

(21) Appl. No.: 15/218,750

(22) Filed: Jul. 25, 2016

Related U.S. Application Data
(60) Provisional application No. 62/196,162, filed on Jul. 23, 2015.

(51) Int. Cl. G06F 19/00; G09B 7/00; H04L 12/58; G06F 17/30; G06Q 10/10; H04L 29/08

(52) U.S. Cl. CPC G06F 19/322; G06Q 10/1095; G06F 19/3418; H04L 67/02; H04L 51/08; G06F 17/30598; G09B 7/00

(57) ABSTRACT

In a community referral cluster technology platform, principal investigators, hospitals, contract research organizations, life sciences partners, or other organizations create an invitation to one or more referring providers who have either in the past, or will in the future, make referrals for patients who require specialized care that the referring provider does not offer directly. The referring provider acts upon invitation, and makes an informed affirmative decision as to the interest of referring patients to the organization for possible involvement in a specified medical treatment. The technology platform identifies, filters, matches, and schedules patients for consultation appointments with the referring provider. The referring provider conducts consultation appointments facilitated by the technology platform and decides if referral to the organization is appropriate.

This patent application claims priority to U.S. provisional patent application Ser. No. 62/196,162, which is hereby incorporated by reference herein.

### TECHNOLOGY FIELD

The present invention relates in general to recruiting patients for clinical trials.

### BACKGROUND AND SUMMARY

Within the health care industry, and in particular within the field of clinical research, there is a need for a more effective process to identify and place candidates for clinical research trials to try new and improved products and services, including but not limited to new and/or potentially improved pharmaceutical products, medical devices, and procedures. Such clinical trials are typically research studies conducted on volunteers to study the effectiveness of a new or improved medical product or service. The sponsor may be a manufacturer of a drug or medical device and funds the clinical trial, often as part of its FDA approval process. Sponsors can include pharmaceutical companies, clinical research organizations, medical device manufacturers, and site management organizations. A principal investigator is typically a research physician or group of physicians that actually conducts the clinical trial for the sponsor.

Volunteers that participate in a given clinical trial must meet certain criteria established by the sponsor and/or the principal investigator. Exemplary criteria, or parameters, may include type of disease, previous treatment history, and other medical conditions that may be affected by participation in the trial, age, and gender. Whether or not certain criteria are inclusive or exclusive typically depends on the nature of the clinical trial itself. Volunteers are carefully advised of the details of the clinical trial to ensure that they are aware of both the positive and negative potential impacts of participating in the trial.

Volunteers may participate in the clinical trial for various reasons, such as an opportunity to gain access to a treatment that they otherwise could not because the treatment is not on the market, has not been approved by the FDA, or they could not afford it; or, they may be motivated by the desire to contribute to medical research, or may simply be motivated to participate because of the money they are paid to participate.

It has been reported that the cost to bring a new drug to market can be one billion dollars. Because only approximately one in ten drugs are ever approved for market by the FDA, adjusting that number for current failure rates results in an estimated four billion dollars in research spent for every drug that is approved. A single clinical trial can cost one hundred million dollars. As a result, pharmaceutical companies have a desire to employ more effective and efficient methods of conducting clinical trials.

According to a Tufts University study, a pharmaceutical company can lose over a million dollars per day in lost drug sales for each day a clinical trial is not complete. The clinical trial process can be slow; one of the main reasons is the time it takes to find a suitable population for the trial. Sufficiently populating a clinical trial often takes more than a year, and represents more than 25% of the entire length of the trial lifecycle.

In addition to clinical trials, pharmaceutical companies, medical device manufacturers, and the like are constantly developing, improving, and discovering new medical treatments or products for medical conditions that may not be well known for the treatment of a certain condition. For example, some pharmaceutical products are not well known within the medical community because they are very expensive and, as such, are seldom used. However, there are often occasions when these drugs are highly effective for a certain condition but the medical provider is not familiar with the drug. There may be other instances where a medical device can be used to treat a condition but the device is not well known because FDA approval was not required. The medical device manufacturers have a need to identify potential candidates for its device and make the medical providers aware of its potential use.

Various traditional techniques are currently used to identify suitable potential candidates for new or little known medical treatments or to participate in a clinical trial. The company or investigator may place advertisements, using various media such as newspaper, radio commercials, billboards, internet advertising, and the like, to find or solicit potential candidates. Information materials may also be given to specialist physicians for a related area of the medical treatment or clinical trial or to support groups for a specific condition. However, success rates using these traditional methods are typically poor due to the inability to reach a large pool of potentially qualified candidates, and those that may be interested and do respond often do not meet the criteria to participate in the study.

Physicians are also often involved in referring patients to clinical trials. However, successful referral rates from physicians are not optimal, because physicians are usually extremely busy and have little time to study available clinical trials and assure their patients meet the necessary criteria for participation in a clinical trial.

Nevertheless, it is relatively straight forward and simple to get a referring provider (such as a primary care provider) to agree to refer their patients who suffer from a specific diagnosis (such as type II diabetes). The referring provider is typically eager to help a fellow provider who is conducting research, as well as intrigued in how the research may benefit his/her patients suffering from a disease being researched. The issue is that the criteria for a patient to be qualified for the clinical trial is often complex and rarely something that a referring provider is going to recall as they spend 5-10 minutes with 50+ patients per day.

This leads to a provider agreeing to refer his/her patients to an organization, but never actually referring a patient due to the time, overhead, and cost associated with identifying patients within his/her practice that qualify. It is thus not easy enough for the referring provider to help his/her fellow researching provider by referring patients.

Thus, a fundamental problem that embodiments of the present disclosure address is the inefficiency and inability for principal investigators, hospitals, contract research organizations, life sciences companies, or any other organization to build and maintain an effective network of referring providers for clinical research. There exists no technology platform or solution for these organizations to help automate, maintain, and scale up a referring network, primarily due to the foregoing reasons.

Embodiments of the present disclosure overcome these gaps and make it easier for principal investigators, hospitals, contract research organizations, life sciences companies, or any other organization to connect, request, and receive patient referrals from providers within their community without altering the primary workflow of the referring provider. Put another way, once a referring provider agrees to make referrals, they are not required to do anything else until possibly when certain ones of their patients that are pre-qualified for a clinical trial begin to show up for scheduled appointments, who are willing and interested in learning more about the clinical trial. This allows the referring provider to focus on determining if, in their medical opinion, the clinical trial is an appropriate course of treatment for a pre-qualified group of patients, and then simply make a referral to their fellow researching provider.

### BRIEF DESCRIPTION OF THE DRAWINGS

FIG. 1 illustrates a block diagram of a technology platform configured in accordance with embodiments of the present disclosure.

FIG. 2 illustrates a schematic of systems and methods for implementing invitations and provider outreach.

FIG. 3 illustrates a schematic of systems and methods for patient identification, outreach, and scheduling.

FIG. 4 illustrates a schematic of patient appointments and referrals.

FIG. 5 illustrates a block diagram of an exemplary system configured in accordance with embodiments of the present disclosure.

FIG. 6 illustrates a flow chart diagram configured in accordance with embodiments of the present disclosure.

### DETAILED DESCRIPTION

While the following terms are believed to be well understood by one of ordinary skill in the art, the following definitions are set forth to facilitate explanation of the presently disclosed subject matter.

Contract Research Organization (“CRO”) refers to an organization that contracts with pharmaceutical and medical device manufactures to outsource the management of clinical trials.

Electronic health record (“EHR”) system refers to a database that electronically stores information about a patient (e.g., their electronic chart). This may also be referred to as the electronic medical record (“EMR”) system.

National Institutes of Health (“NIH”) is a part of the U.S. Department of Health and Human Services, which is the nation's medical research agency.

The terms “program director” (“PD”) and “principal investigator” (“PI”) refer to individual(s) designated by an organization to have the appropriate level of authority and responsibility to direct a clinical study, such as a project or program supported by an award from the NIH.

The term “provider” refers to a physician, physicians' assistant, nurse practitioner, or any other credentialed person that provides medical services and/or advice to patients.

A specific medical treatment, as used herein, may be a clinical trial, clinical study, clinical research, medical treatment, medical product, pharmaceutical drug, pharmaceutical treatment, precision medicine, medical device, or the like. Precision medicine is a medical model that proposes the customization of healthcare, with medical decisions, practices, and/or products being tailored to the individual patient. For example, precision medicine may include using genetic information about a person to diagnose or treat their disease.

At a high level, embodiments of the present disclosure implement three phases for building, operating, and scaling a community referral cluster technology platform:

1. Principal investigators, hospitals, contract research organizations, life sciences partners, or other organizations create an invitation to one or more referring providers who have either in the past, or will in the future, make referrals for patients who require specialized care that the referring provider does not offer directly. The referring provider acts upon invitation, and makes an informed affirmative decision as to the interest of referring his/her patients to the organization for possible involvement in a specified medical treatment.

2. The technology platform identifies, filters, matches, and schedules patients for consultation appointments with the referring provider.

3. The referring provider conducts consultation appointments facilitated by the technology platform and decides if referral to the organization is appropriate.

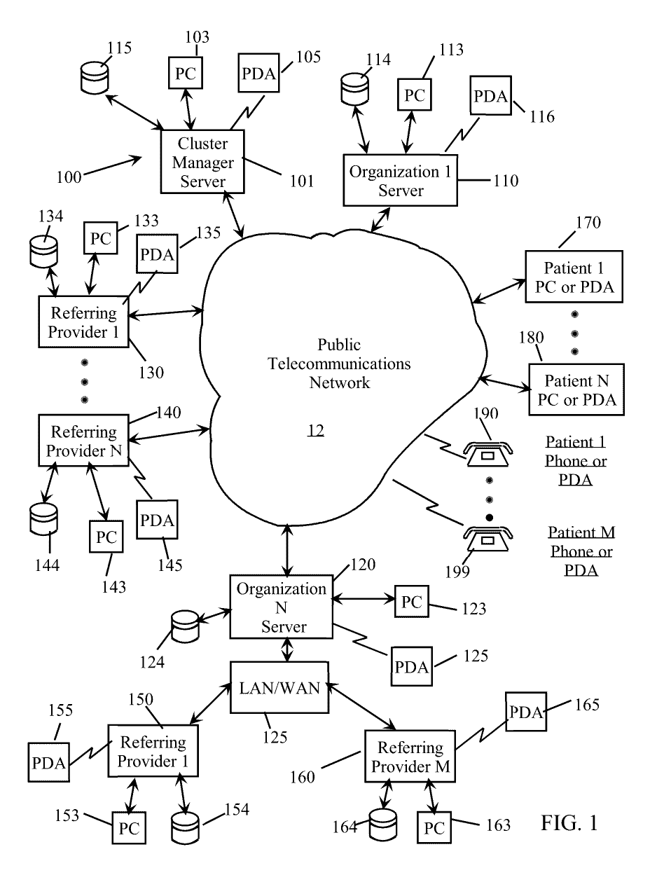

Referring initially to FIG. 1, a block diagram is illustrated of a technology platform 10 configured in accordance with embodiments of the present disclosure. As will be further described hereinafter, various computer servers, personal computing devices, and other telecommunications devices (e.g., telephone devices), may be coupled to one or more of each other during various instances and periods of time through a public telecommunications network (“PTN”) 12. The PTN 12 may include any one or more of the various telecommunications networks, including the Internet, implemented throughout the world for enabling communications between persons and devices coupled to the PTN 12. Please note that the configuration illustrated in FIG. 1 is exemplary, and embodiments of the present disclosure are not limited to this exact configuration.

The technology platform 10 illustrates various computer servers 101, 110 . . . 120, and 130 . . . 140 coupled to the PTN 12. These servers may be coupled to the PTN 12 through any combination of hubs, switches, routers, and the like. Furthermore, such connections between the servers may be implemented through the utilization of intermediary local area networks (“LANs”) and/or wide area networks (“WANs”). Further, the exemplary network architecture of the technology platform 10 illustrated in FIG. 1 shows one or more personal computing devices 170 . . . 180 (e.g., personal computers (“PCs”) and personal digital assistants (“PDAs”) and the like), and one or more telecommunications devices (e.g., telephones) 190 . . . 199 coupled to the PTN 12. As with the servers, such personal computing devices and telecommunications devices may be coupled to the PTN 12 with any combination of hubs, switches, routers, and the like. Those skilled in the art will appreciate that the technology platform 10 may assume other forms, including providing network conductivity through the Internet or other telecommunications networks. The technology platform 10 may include other servers, which may all be widely dispersed geographically from each other to support client computers in other locations.

One or more of the servers may be further coupled to a network to other servers. For example, the server 120 is illustrated as coupled to the servers 150 . . . 160 through a network 125, which may comprise a LAN, WAN, or virtual private network (“VPN”) implemented within another network (e.g., the PTN 12). One or more of the servers 101, 110 . . . 120, 130 . . . 140, and 150 . . . 160 may be coupled to one or more client computing devices, such as personal computers, and one or more database storage devices (e.g., database servers). Furthermore, one or more of the servers may communicate with one or more PDAs authorized to access the attributes of the server. For example, the server 101 may be coupled to one or more personal computers 103, databases 104, and/or PDAs 105. The server 110 may be coupled to one or more personal computers 113, databases 114, and/or PDAs 116. The server 130 may be coupled to one or more personal computers 133, databases 134, and/or PDAs 135. The server 140 may be coupled to one or more personal computers 143, databases 144, and/or PDAs 145. The server 120 may be coupled to one or more personal computers 123, databases 124, and/or PDAs 125. The server 150 may be coupled to one or more personal computers 153, databases 154, and/or PDAs 155. The server 160 may be coupled to one or more personal computers 163, databases 164, and/or PDAs 165.

With respect to the exemplary embodiments of the present disclosure discussed herein, the server 101 will be discussed as implemented and configured as the cluster manager server 101 for the community cluster manager 100. Organizations discussed herein that desire to conduct specific medical treatments, referring providers, and patients may communicate with each other and/or the cluster manager 100 via the technology platform 10.

The community cluster manager 100 utilizes the technology platform 10 to identify potential patients for the specific medical treatments to be conducted by any organization that performs such specific medical treatments, including, but not limited to, principal investigators, hospitals, contract research organizations, and life sciences companies. Such organizations may be coupled to the technology platform 10 through the organization's computer network. For example, referring to FIG. 1, an exemplary Organization 1 may be coupled to the technology platform 10 through its server 110, which may be coupled to one or more of the aforementioned personal computers 113, databases 114, and or PDAs 116. Embodiments of the present disclosure link to and communicate with, on a continuous and/or intermittent basis, N such organizations (where N≧1). As an example, an Organization N may be coupled to the PTN 12 of the technology platform 10 through its computer server 120, which may be further coupled to one or more personal computers 123, databases 124, and/or PDAs 125.

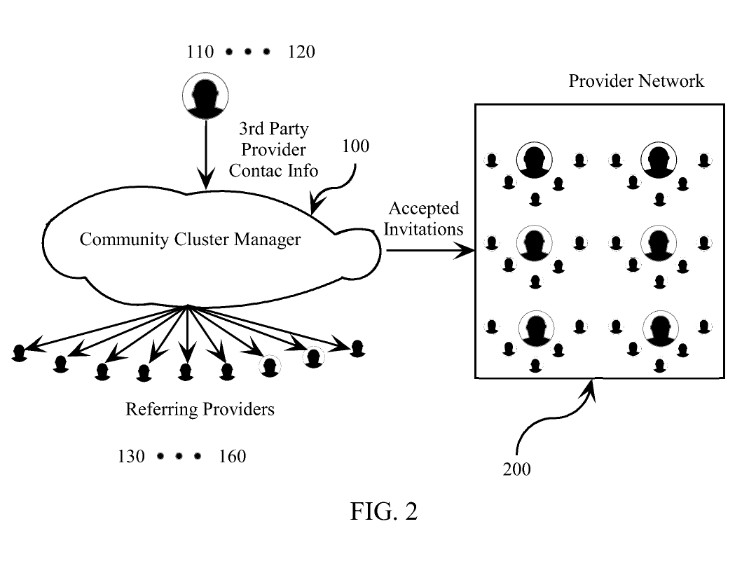

Referring to FIG. 2, after the cluster manager 100 has identified an organization that is in need of patients for its specific medical treatment, the cluster manager 100 will set up a communications link between the cluster manager server 101 and the organization's server (e.g., any one or more of the N organization servers 110 . . . 120). The N organizations 110 . . . 120 provide contact information of one or more third parties who the organization has identified as having provided, either in the past, or will in the future, referrals for patients who require specialized care that the third party does not directly offer to such patients. Herein, such third parties are also referred to as referring providers, which as previously noted may be physicians, including primary care providers.

Additionally, one or more of the N organizations may communicate the criteria associated with a particular specific medical treatment being conducted, or planned, by the organization. One or more of the N organizations may communicate such criteria from its server to the cluster manager server 101 through the utilization of a graphical user interface (“GUI”) created by the cluster manager 100. For example, the cluster manager 100 may send an HTTP hyperlink to an organization, such as through an email or text, from the cluster manager server 101 to a PC (e.g., PCs 113 . . . 123) or PDA (e.g., PDAs 116 . . . 125) coupled to the organization's server (e.g., organization servers 110 . . . 120). A person at a PC or PDA may then use the hyperlink to interface with the GUI to input the criteria associated with that organization's specific medical treatment. Such a GUI may be designed for implementation on a webpage created by the cluster manager 100 utilizing one or more of the PCs 103 coupled to the cluster manager server 101. In embodiments of the present disclosure, such a webpage may be presented to the organization via an Internet portal site.

Invitations to one or more referring providers are then transmitted based on the contact information provided by the N organizations. Such invitations may be facilitated by the cluster manager 100 and may be distributed in various ways. An exemplary process for sending an invitation to a referring provider is via direct mail/letter. For example, the organization providing the contact information for a referring provider may send a piece of direct mail/letter to the referring provider to invite the referring provider to join the community referral cluster, which will connect the referring provider to the technology platform 10. As an example, an invitation code may be printed within the piece of direct mail/letter, which the referring provider will then utilize to connect to the community referral cluster implemented within the technology platform 10. Such an invitation code may be generated on a PC 103 by the cluster manager 100, which is then embedded within an electronic document sent through the cluster manager server 101 to the organization. As an example, Organization 1 may receive the electronic document with the embedded invitation code on its PC 113 through the PTN 12 and the organization server 110. Organization 1 may then print out the direct mail/letter using the received electronic document, which includes the embedded invitation code, from the PC 113 for subsequent direct mailing to the referring provider to be invited.

The referring provider may be any one or more of the N referring providers 130 . . . 160 (where N≧1), who will then decide whether they agree to join the community referral cluster and couple their computer system to the technology platform 10. If the referring provider desires to be coupled to the technology platform 10, the referring provider may then access an entry point provided in the direct mailing (e.g., a web-based portal) into the technology platform 10 (e.g., through the use of a GUI) by which the referring provider enters the invitation code. As an example, Referring Provider 1 utilizes the PC 133, which may be coupled through the server 130 for access to the PTN 12 (or may be directly coupled to the PTN 12 in an instance where the referring provider does not implement a central computer server for its operations). Referring Provider 1 may then access the GUI by accessing a website created by the cluster manager 100 on the PC 103 coupled to the cluster manager server 101. By way of that GUI, Referring Provider 1 will enter the invitation code, which then couples the computer system of Referring Provider 1 to the technology platform 10 that is implementing the community referral cluster.

Alternatively, such an invitation to a referring provider may be sent through direct mail/letter by the cluster manager 100 in a manner similarly described above with respect to the organization sending such a direct mailing. In other words, the cluster manager 100 will print out a direct mail/letter with the embedded invitation code from the PC 103 to be sent to the referring provider. As with the description above, such an exemplary referring provider, such as Referring Provider 1, may then couple their computer system (e.g., server 130) to the community referral cluster implemented on the technology platform 10 in a similar manner utilizing the embedded invitation code.

Note that the embedded invitation code may take any appropriate and known form for accessing an entry point and connecting to the technology platform 10, such as the utilization of a specifically designed QR Code printed on the invitation letter. Further, each invitation code may be unique, and/or may be automatically generated by a software program in the server 101 or the PC 103 for assignment to the particular referring provider being invited.

Another exemplary process for inviting one or more referring providers is through the utilization of a direct email sent by the organization to the referring provider(s). For example, the cluster manager 100 may create on the PC 103 such an email template that is then delivered to the organization via the technology platform 10, such as through the cluster manager server 101, the PTN 12, the organization's server (e.g., one or more of the servers 110 . . . 120), to the organization's PC (e.g., PCs 113 . . . 123) or PDA (e.g., PDAs 116 . . . 125). The organization may then redirect such an email from the organization's PC to the referring provider(s) to be invited. The email template may be automatically created with a generated invitation code and/or HTTP hyperlink embedded within the email. For example, if Referring Provider 1 receives the email invitation on the PC 133 or PDA 135, Referring Provider 1 can then connect to the community referral cluster implemented on the technology platform 10 through a GUI implemented within a webpage created by the cluster manager 100, which the referring provider accesses by clicking on the embedded HTTP hyperlink within the received email. Such an HTTP hyperlink may automatically forward Referring Provider 1 to a webpage or portal, which may include an agreement the referring provider has to agree to (e.g., by affirmatively clicking a GUI box), for joining the community referral cluster. Alternatively, Referring Provider 1 may utilize the invitation code embedded within the received email to enter into the GUI implemented by the webpage, which will then couple the server 130 of Referring Provider 1 to the community referral cluster technology platform 10.

Alternatively, such direct emails to referring providers to be invited may be sent by the cluster manager 100 from the PC 103 through the cluster manager 101, the PTN 12, to any one or more of the N referring providers 130 . . . 140. Likewise, such emailed invitations may be sent by an organization from its PC 123 or PDA 125 through its server 120 and network 125 to one or more of the M (where M≧1) referring providers 150 . . . 160 coupled to the organization within its network. Or, the organization may authorize the cluster manager 100 to send such emailed invitations to the one or more M referring providers 150 . . . 160 directly from the PC 130 through the cluster manager server 101, the PTN 12, the server 120, the network 125, to the referring providers on their PCs 153 . . . 163 or PDAs 155 . . . 165.

Another example of a process for inviting referring providers into the community referral cluster may be performed through the utilization of SMS/text messaging. Such an SMS/text message may be created by the cluster manager 100 (or automatically created by the server 101 or PC 103) and delivered through the technology platform 10 to the organization for transmission from the organization's computer device. Alternatively, such an SMS/text message may be directly sent from the cluster manager 100 to the one or more referring providers to be invited to the community cluster. Such an SMS/text message may include an embedded invitation code and/or HTTP hyperlink, which the invited referring provider utilizes to connect to the technology platform 10, in a manner as already previously described. For example, the inviting organization and/or the cluster manager 100 may utilize their PC 103 or PDA 105 to forward such an SMS/text message to invite the referring provider(s).

Another example of a process for inviting referring providers to be coupled to the technology platform 10 of the community referral cluster is by direct phone interaction between either the organization or directly by the cluster manager 100. As an example, an organization, such as Organization 1, may utilize a cell/land telephone line over the PTN 12 to call a referring provider to be invited and provide the referring provider with the invitation code and/or HTTP hyperlink to connect to the technology platform 10 of the community referral cluster.

Embodiments of the present disclosure may further implement an interactive voice response (“IVR”) system implemented within the cluster manager server 101 for automatically interacting with an invited referring provider to thereby invite and couple the referring provider to the community referral cluster technology platform 10.

With all of the foregoing examples of techniques in which referring providers may be invited into the community referral cluster to couple to the technology platform 10, a third party sales representative may be utilized to facilitate any of such invitation techniques, including direct mail/letter, email, SMS/text messaging, and/or direct telephone communication.

Referring again to FIG. 2, those referring provider(s) 130 . . . 160 that elect to join the community referral cluster by accepting the invitation (and entering the invitation code) are then coupled into a provider network 200 along with the organizations for further communications and interactions via the technology platform 10. The result of the foregoing is that the referring provider network 200 includes referring providers who have made an informed and affirmative decision by indicating via one of the aforementioned modalities their interest in referring their patients for possible inclusion within any one or more of the specific medical treatments being operated by one or more of the organizations.

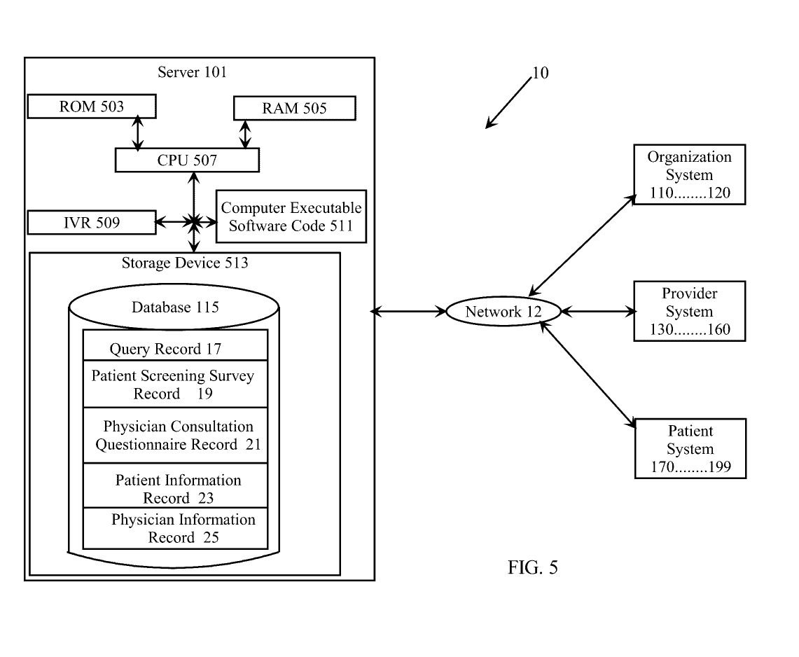

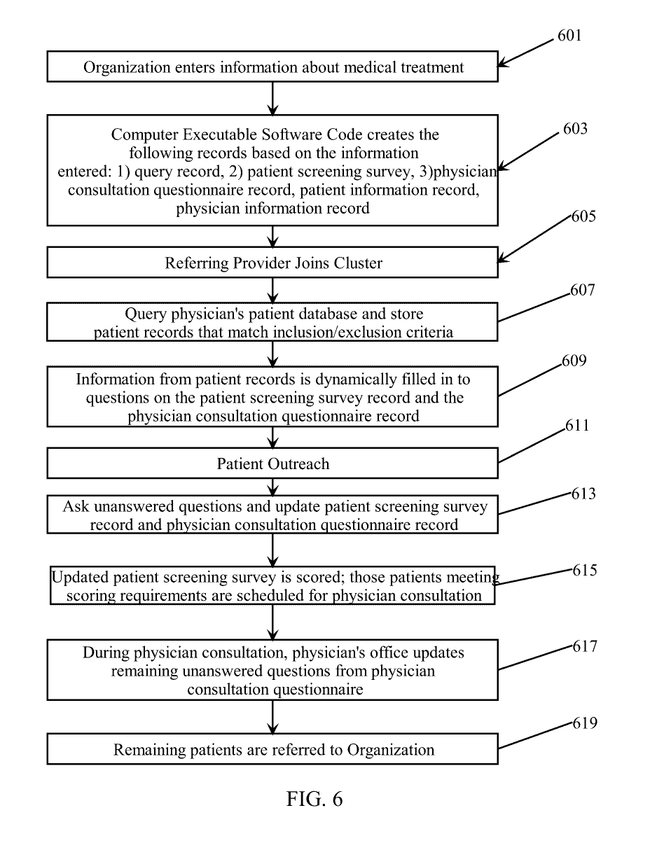

Once a referring provider is coupled to the community referral cluster technology platform 10, the cluster manager server 101 may utilize a technology mining technique (e.g., see FIGS. 5-6) implementing a multi-tier filtering and matching process that automatically begins accessing each referring provider's electronic health records (“EHR”) system to filter and match patients within such EHR systems against a multitude of data points gathered from multiple sources, including but not limited to, the referring provider's EHR system. This access may be made over a secure network connection (e.g., a VPN) over the PTN 12, which may be facilitated by the referring provider entering the required information for accessing their EHR system when the referring provider accepts the invitation to join the community referral cluster.

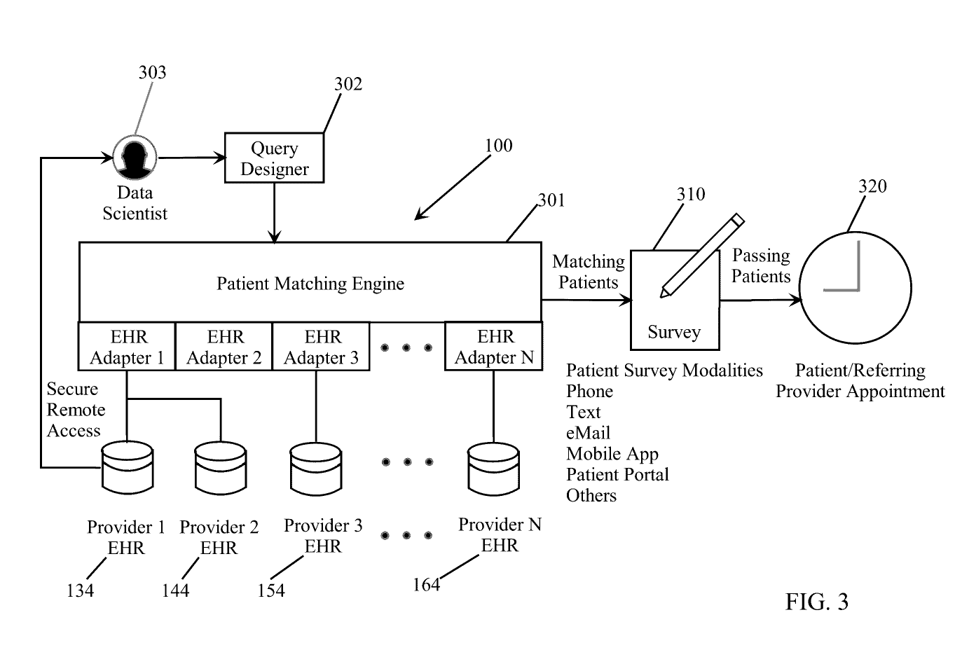

FIG. 3 illustrates a schematic of a patient identification, outreach, and scheduling technology platform, which may be implemented within the community referral cluster technology platform 10 of FIG. 1. As previously disclosed, one or more specific medical treatments have been previously provided to the cluster manager 100, along with the criteria for matching potential patients with such specific medical treatments. As an example, a data scientist 303 may access the cluster manager 100 through the use of a PC 103 and prepare and design computer executable software code (e.g., see 511 of FIG. 5) configured to conduct a query (e.g., see process block 607 of FIG. 6) for mining for potential patients from the various databases of patients (e.g., EHR databases 134 . . . 164) now accessible through the referring providers that have been coupled to the community referral cluster technology platform 10. The query 302 may then be published, or transmitted, for use by a patient matching engine 301, which may be implemented in computer executable software code (e.g., 511) within the PC 103 and/or the cluster manager server 101. The patient matching engine 301 performs a portion of the aforementioned multi-tier filtering and matching process by submitting the query to the EHR systems within the referring providers' computer systems. Such EHR systems are well-known in the art. As an example, the one or more N referring providers 130 . . . 140 may store their patient information within their respective EHR systems 134 . . . 144. Likewise, the M referring providers 150 . . . 160 may store their patient information within their respective EHR systems 154 . . . 164. Since each EHR system may be uniquely configured within the referring provider's computer system, the patient matching engine 301 may utilize a well-known EHR adapter in order to implement the appropriate communication protocols for satisfactorily communicating with and accessing the patient information stored within a corresponding EHR system.

As a query (e.g., see process block 607 of FIG. 6) is submitted by the patient matching engine 301 to any one or more of the EHR systems 134 . . . 164, it will utilize the criteria provided for a particular specific medical treatment to identify patients within such EHR systems for further contact and investigation for possible inclusion within such a specific medical treatment. As an example, the patient matching engine 301 may identify a particular patient within one of the EHR systems 134 . . . 164 when a certain threshold score is reached or obtained for that particular patient as a function of a matching between the patient's information stored within the EHR system and the predetermined criteria within the query. Examples of scoring are described hereinafter with respect to FIG. 6. The information associated with a matching patient is then transmitted from the particular EHR system (e.g., EHR systems 134 . . . 164) from the referring provider's computer system, through the PTN 12, to be stored within a database 104 coupled to the cluster manager server 101.

The client manager 100 may then conduct outreach to a matching patient to schedule that patient with a consultation appointment with the patient's referring provider. For example, an identified matching patient may be contacted by the cluster manager 100 using any one of the aforementioned modalities (e.g., phone, text, email, mobile app, patient portal, etc.). That identified matching patient may be further linked to the cluster manager 100 in order to provide further information, complete a patient survey, and/or schedule an appointment with the patient's referring provider. As a non-limiting example, an email may be created and delivered (e.g., automatically) from the cluster manager 100 through the PTN 12 to the patient, such as the patient's PC or PDA. For example, one or more N patients (wherein N≧1) may be sent an email from the cluster manager 100 over the PTN 12 to the patient PC or PDA (e.g., patient PCs 170 . . . 180). Within such an email, there may be an embedded HTTP hyperlink that upon mouse clicking by the patient will take the patient to a website and/or portal designed and operated by the cluster manager 100, for example with a GUI that interfaces with the patient for obtaining further information from the patient, conducting an online survey with the patient, and/or scheduling the patient for an office appointment with the patient's referring provider.

It should be noted that with some embodiments of the present disclosure, the information obtained through the online survey conducted with a particular patient may result in the patient no longer being a match for the corresponding specific medical treatment, whereby the patient may be informed via the GUI of such a lack of a match. If during such a session with the patient, the patient continues to be a potential match for the specific medical treatment, then the patient may be provided with the telephone or website information of that client's referring provider to thereby contact the referring provider to schedule a follow-up appointment. For example, the GUI may include an HTTP hyperlink to the patient's referring provider's scheduling system website/portal, whereby the patient is then automatically linked to this website/portal. Or, the cluster manager 100 may have a further scheduling application and process implemented in the cluster manager server 101 whereby such system has downloaded from the referring provider's scheduling system known open appointment slots so that the client manager system can then interact with the patient through the GUI to schedule the patient on behalf of the patient's referring provider.

As a non-limiting example, referring to FIGS. 1 and 3, an identified matching patient may be transmitted an email over the PTN 12 from the cluster manager 100 to the patient's PC or PDA 170 with an embedded HTTP hyperlink, which then connects the patient PC or PDA 170 to the cluster manager server 101 over the PTN 12. If, after receiving further information from the patient (e.g., during the survey 310), this particular patient continues to be identified as a match for the particular specific medical treatment for which the patient was initially identified and contacted for, such a matching patient may then be scheduled using this interaction between the patient PC or PDA 170 and the cluster manager server 101 to schedule the patient for an appointment 320 with that patient's referring provider (e.g., referring providers 130 . . . 160).

Within some embodiments of the present disclosure, at no point during the foregoing process has the referring provider pertaining to the contacted patient participated in such a pre-qualification process 310. From the referring provider's point of view, he/she has previously agreed to join the community referral cluster, and then at a time later, patient(s) begin to show up for the further consultation appointment(s) to discuss the one or more specific medical treatments offered through the community referral cluster.

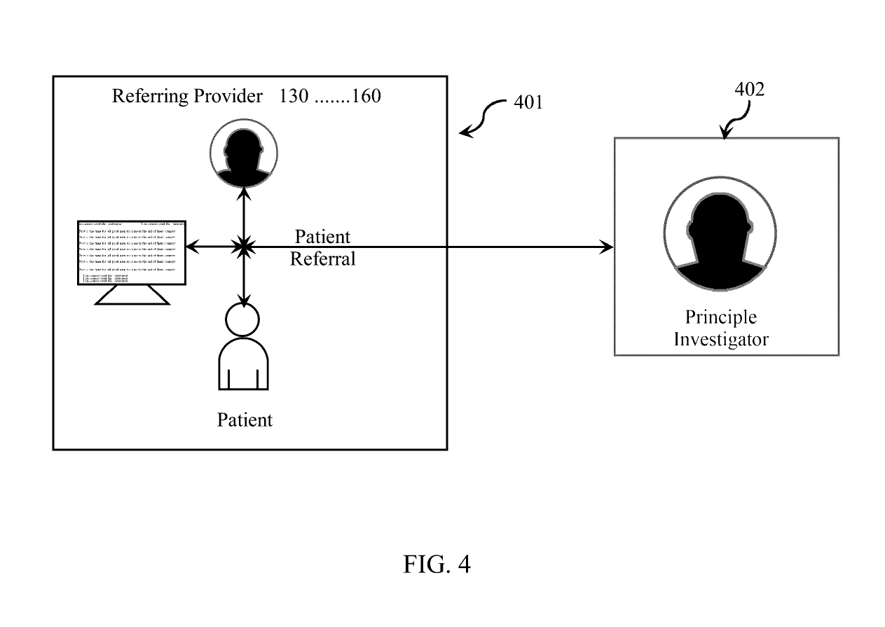

Referring to FIG. 4, when a patient has been scheduled for an appointment with the patient's referring provider (see 320 in FIG. 3), the patient then arrives at the referring provider's office for the consultation appointment 401. The referring provider may then access the patient's information on the referring provider's EHR system along with information provided by the cluster manager 100 indicating how this particular patient is a potential match for the specific medical treatment. Since the cluster manager 100 has access to the referring provider's EHR system, all of such information about the patient may be provided by the cluster manager 100 to the referring provider via the technology platform 10. As a non-limiting example, Referring Provider 1 may access the patient's information on the EHR system 134 through the PC 133, while also accessing the relevant information as to why the patient is a potential match for the specific medical treatment received from the cluster manager 100 through the cluster manager server 101, the PTN 12, and the referring provider's server 130. Or, all of the relevant information may be provided to Referring Provider 1 on the PC 133 by accessing a website or portal created by the cluster manager 100. Such additional information may include, but is not limited to, all of the inclusion/exclusion criteria of the specific medical treatment, any additional information previously gathered by the patient matching engine 301, and/or any patient information directly obtained from the patient through the previously noted survey 310 conducted by the client manager 100 with the patient.

The referring provider may be asked to complete a consultation questionnaire with the patient that may further determine the eligibility of this particular patient for the specific medical treatment. Such an additional consultation questionnaire may be transmitted to the referring provider utilizing the technology platform 10 from the client manager 100. The client manager 100 may further implement a scoring algorithm (for example, similar to the exemplary scoring described hereinafter with respect to FIG. 6) that includes the additional information obtained through this consultation questionnaire between the referring provider and the patient to add to the previous information about the patient to then determine whether such a scoring continues to indicate that the patient is a match for the specific medical treatment. If the referring provider then determines that the patient should be referred for the specific medical treatment, and the patient is agreeable, the referring provider communicates this referral directly through the technology platform 10 to the cluster manager 100. The cluster manager 100 will then facilitate the scheduling of the referred patient through additional patient engagement workflows to schedule this patient directly with the organization 402 (e.g., a principle investigator) running the specific medical treatment. Again, a GUI may be utilized within the technology platform 10 in order to schedule the patient for the next appointment with the organization 402 for initiating the specific medical treatment.

Referring now to FIGS. 5-6, the following presents a non-limiting example of systems and methods for implementing the aforementioned technology mining technique implementing a multi-tier filtering and matching process for matching patients to a specific medical treatment, which is also described in U.S. patent application Ser. No. 14/162,743, which is hereby incorporated by reference herein. FIG. 5 is a block diagram illustrating an exemplary system in accordance with embodiments of the present disclosure. FIG. 6 is a flowchart diagram illustrating an exemplary process in accordance with embodiments of the present disclosure.

A server 101 (e.g., the cluster manager server 101) may contain a read-only memory (“ROM”) 503 and a random access memory (“RAM”) 505, as well as a central processing unit (“CPU”) 507. An interactive voice response (“IVR”) system 509 and computer executable software code 511, as well as a storage device 513, may reside on the server 101. The database 115 may be stored on the storage device 513 and contain certain records relating to a specific medical treatment as further described hereinafter. The server 101 is connected to the network 12.

In process block 601, an organization (e.g., Organizations 1 . . . N) looking for potential candidates for a specific medical treatment may connect to the server 101 through the network 12 using the organization server 110 . . . 120. The computer executable software code 511 may guide the organization to enter specified information about the specific medical treatment that the organization is recruiting potential candidates for. The specified information may include the name of a medical condition to be treated, an Institutional Review Board approved description of the specific medical treatment, inclusion and exclusion criteria for the potential candidates, patient compensation, referral compensation, information about the specific medical treatment for the referring providers, geographic locations of available sites for the specific medical treatment, and the like.

In process block 603, the cluster manager of the server 101 accesses the information about the specific medical treatment that has been input by the organization and, after reviewing the information for completeness and approving the information, launches computer executable software code 511 that automatically creates the following records based on the information received from the organization: a medical treatment specific query record 17, a medical treatment specific patient screening survey record 19, a medical treatment specific physician consultation questionnaire record 21, a medical treatment specific patient information record 23, and a medical treatment specific physician information record 25. These records may be stored in the database 115 on the server 101. The computer executable software code 511 may apply a score to each of the possible answers to the patient screening survey. The score for each answer of the patient screening survey may be predetermined by the user for use by the computer executable software code. Such scores may be an integer number of varying amount, including positive and negative numbers and/or a zero value. For example, if the answer to a question is a “yes” or “no,” then a “yes” answer can be given a score of a positive integer (e.g., +1, +2, etc.), while a “no” answer can be given a score of a negative integer (e.g., −1, −2, etc.), with the magnitude of the positive or negative integer weighted as a function of the relative importance of the question for determining the eligibility of the potential patient for the specific medical treatment. The scores may also be predetermined so that a sum of them must be greater than a predetermined threshold amount in order to qualify the patient for further evaluation for possible inclusion within a specific medical treatment.

In process block 605, upon receiving an invitation to join a community referral cluster 10, a referring provider's office may connect to the server 101 through the network 12 using the referring provider's system 130 . . . 160. The referring provider's system 130 . . . 160 includes the provider's patient database 134 . . . 164. The referring provider may then browse the physician information records 25 to search for a specific medical treatment being recruited. The physician information records 25 may include location, specialties, compensation, whether the physician has participated in recruiting potential candidates for a related medical treatment or company, benefits for said potential patient, cost of said medical treatment, whether said medical treatment is new or a new indication of a known medical treatment and the like. The computer executable software code 511 may allow the referring provider to sort the available medical treatments based on the information in the physician information records 25. Once the referring provider finds a specific medical treatment that he agrees might be beneficial for his patients, the referring provider can select the specific medical treatment and agree to opt in to the community referral cluster 10. By collecting and sorting information about the specific medical treatment the provider is shown medical treatments that he is likely to be interested in. In another embodiment of the present disclosure, this matching algorithm may be used to recommend medical treatments to referring providers on a weekly basis.

Process block 607 begins the first of three tiers in the qualification system and method of identifying potential candidates and/or patients for a specific medical treatment. In process block 607, a secure connection is made between the referring provider's system 130 . . . 160 and the server 101. The computer executable software code 511 (e.g., the patient matching engine 301 of FIG. 3) then accesses the medical treatment specific query record 17 and runs the query on the referring provider's EHR system, storing those patient records that match the inclusion and exclusion criteria on the server 101 in the database 115.

In process block 609, the computer executable software code 511 (e.g., the patient matching engine 301 of FIG. 3) compares information obtained from the patient record of the referring provider's EHR system with questions from the medical treatment specific patient screening survey record 19 and the medical treatment specific physician consultation questionnaire record 21. The computer executable software code 511 may then dynamically complete those fields in the medical treatment specific patient screening survey record 19 and the medical treatment specific physician consultation questionnaire record 21 that match information from the patient record in the EHR system.

As previously described with respect to FIG. 3, the patient matching engine 301 may perform the query of process block 607 resulting in at least one patient identified as a potential match for the specific medical treatment. In process block 611, the aforementioned patient outreach by the client manager 100 is performed in order to determine if the patient is interested in the specific medical treatment, and if so, to obtain further information from the patient. The cluster manager 100 may then contact a patient using one of the previously described modalities to inquire whether the patient is interested in learning more about the specific medical treatment for which the patient has passed the first tier of the qualification process. If the patient is interested in continuing in the qualification process, the patient may be transferred to an interactive voice response system 509, or to a website to complete an online survey.

Process block 613 begins the second of three tiers in the qualification system and method of identifying potential candidates and/or patients for a specific medical treatment (e.g., see 310 of FIG. 3). In process block 613, in some embodiments of the present disclosure, once the patient has been connected with the interactive voice response system 509, the patient completes the medical treatment specific patient screening survey. The interactive voice response system 509 accesses the medical treatment specific patient screening survey record 19 and asks the patient all questions that remain unanswered, or unmatched from the dynamically completed information from step 609. As the patient answers questions through the interactive voice response system 509, the interactive voice response system 509 fills in the unanswered/unmatched questions on the medical treatment specific patient screening survey record 19 and the medical treatment specific physician consultation questionnaire record 21 and stores these updated records in the database 115 on the server 101.

In other embodiments of the present disclosure, instead of transferring the patient to an interactive voice response system 509 connected to the server 101, the patient is directed (e.g., via a HTTP hyperlink) to a website hosted on the server 101. The patient connects to the website hosted on the server 101 through the network 12 (e.g., using a browser on the patient's PC or PDA 170 . . . 180). The patient is then presented all of the questions that remain unanswered from the medical treatment specific patient screening survey record 19, or the unmatched fields from the dynamically completed information from step 609. The patient then answers the unanswered/unmatched questions and the answers are sent through the network 12 to the server 101, where the medical treatment specific patient screening survey record 19 and the medical treatment specific physician consultation questionnaire record 21 are updated in the database 115 and stored on the server 101.

In process block 615, the computer executable software code 511 then scores the answers in the updated medical treatment specific patient screening survey record 19, and those patients that meet a predetermined required threshold score are scheduled (e.g., see 320 of FIG. 3) for a consultation with the referring provider's office (e.g., the aforementioned consultation 401).

Process block 617 begins the third of three tiers in the qualification system and method of identifying potential candidates and/or patients for a medical treatment. When the patient arrives at the referring provider's office for a consultation (e.g., see 401 of FIG. 4), the provider or suitable staff member, using the referring provider's system 130 . . . 160, connects to the server 101 over the network 12 and is presented with the medical treatment specific physician consultation questionnaire that is derived from the medical treatment specific physician consultation questionnaire record 21. During the consultation 401, the provider or suitable staff member views the information that has been completed to date and completes the unanswered questions, or unmatched fields in the medical treatment specific physician consultation questionnaire record 21. The updated answers are then sent to the server 101 and stored in the database 115. This is the opportunity for the referring provider to enter information that the patient would not know, such as a specific lab test result, and that was not able to be queried by the patient matching engine 301 in process block 607 because it was not structured data, was a scanned in document, or was not mapped correctly.

In process block 619, the computer executable software code 511 may then send the patient record associated with the patient(s) that have passed the three-tiered qualification process to the organization (e.g., Organization 1 . . . N) 402 looking for potential candidates for the specific medical treatment. Information sent to the organization may include the medical treatment specific patient screening survey, medical treatment specific physician consultation questionnaire, as well as a Continuity of Care Document or Continuity of Care Record that contains the patient's medical records.

As will be appreciated by one skilled in the art, aspects of the present disclosure may be embodied as a system, method, and/or program product. Accordingly, aspects of the present disclosure may take the form of an entirely hardware embodiment, an entirely software embodiment (including firmware, resident software, micro-code, etc.), or embodiments combining software and hardware aspects that may all generally be referred to herein as a “circuitry,” “module,” or “system.” Furthermore, aspects of the present disclosure may take the form of a program product embodied in one or more computer readable storage medium(s) having computer readable program code embodied thereon. (However, any combination of one or more computer readable medium(s) may be utilized. The computer readable medium may be a computer readable signal medium or a computer readable storage medium.)

A computer readable storage medium may be, for example, but not limited to, an electronic, magnetic, optical, electromagnetic, infrared, biologic, atomic, or semiconductor system, apparatus, controller, or device, or any suitable combination of the foregoing. More specific examples (a non-exhaustive list) of the computer readable storage medium may include the following: an electrical connection having one or more wires, a portable computer diskette, a hard disk, a random access memory (“RAM”) 505, a read-only memory (“ROM”) 503, an erasable programmable read-only memory (“EPROM” or Flash memory), an optical fiber, a portable compact disc read-only memory (“CD-ROM”), an optical storage device, a magnetic storage device, or any suitable combination of the foregoing (e.g., see 513). In the context of this disclosure, a computer readable storage medium may be any non-transitory tangible medium that can contain or store a program for use by or in connection with an instruction execution system, apparatus, controller, or device. Program code embodied on a computer readable signal medium may be transmitted using any appropriate medium, including but not limited to wireless, wire line, optical fiber cable, RF, etc., or any suitable combination of the foregoing.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, controller, or device.

The flowcharts and block diagrams in the figures illustrate architecture, functionality, and operation of possible implementations of systems, methods and program products according to various embodiments of the present disclosure. In this regard, each block in the flowcharts or block diagrams may represent a module, segment, or portion of code, which comprises one or more executable program instructions for implementing the specified logical function(s). It should also be noted that, in some implementations, the functions noted in the blocks may occur out of the order noted in the figures. For example, two blocks shown in succession may, in fact, be executed substantially concurrently, or the blocks may sometimes be executed in the reverse order, depending upon the functionality involved.

Modules implemented in computer executable software code for execution by various types of processors may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The data may provide electronic signals on a system or network.

These program instructions may be provided to a processor (e.g., CPU 507) and/or controller of a general purpose computer, special purpose computer, or other programmable data processing apparatus (e.g., controller) to produce a machine, such that the instructions, which execute via the processor of the computer or other programmable data processing apparatus, create means for implementing the functions/acts specified in the flowchart and/or block diagram block or blocks.

It will also be noted that each block of the block and/or flowchart diagrams, and combinations of blocks in the block and/or flowchart diagrams, can be implemented by special purpose hardware-based systems that perform the specified functions or acts, or combinations of special purpose hardware and computer instructions. For example, a module may be implemented as a hardware circuit comprising custom VLSI circuits or gate arrays, off-the-shelf semiconductors such as logic chips, transistors, controllers, or other discrete components. A module may also be implemented in programmable hardware devices such as field programmable gate arrays, programmable array logic, programmable logic devices or the like.

Computer program code, i.e., instructions, for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

These program instructions may also be stored in a computer readable storage medium that can direct a computer, other programmable data processing apparatus, controller, or other devices to function in a particular manner, such that the instructions stored in the computer readable medium produce an article of manufacture including instructions which implement the function/act specified in the flowchart and/or block diagram block or blocks.

The program instructions may also be loaded onto a computer, other programmable data processing apparatus, controller, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

One or more databases may be included in a host for storing and providing access to data for the various implementations. One skilled in the art will also appreciate that, for security reasons, any databases, systems, or components of the present disclosure may include any combination of databases or components at a single location or at multiple locations, wherein each database or system may include any of various suitable security features, such as firewalls, access codes, encryption, de-encryption and the like. The database may be any type of database, such as relational, hierarchical, object-oriented, and/or the like. Common database products that may be used to implement the databases include DB2 by IBM, any of the database products available from Oracle Corporation, Microsoft Access by Microsoft Corporation, or any other database product. The database may be organized in any suitable manner, including as data tables or lookup tables.

Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a key field in each of the manufacturer and retailer data tables. A key field partitions the database according to the high-level class of objects defined by the key field. For example, a certain class may be designated as a key field in both the first data table and the second data table, and the two data tables may then be merged on the basis of the class data in the key field. In these embodiments, the data corresponding to the key field in each of the merged data tables is preferably the same. However, data tables having similar, though not identical, data in the key fields may also be merged by using AGREP, for example.

Reference throughout this specification to “one embodiment,” “embodiments,” or similar language means that a particular feature, structure, or characteristic described in connection with the embodiments is included in at least one embodiment of the present disclosure. Thus, appearances of the phrases “in one embodiment,” “in an embodiment,” “embodiments,” and similar language throughout this specification may, but do not necessarily, all refer to the same embodiment. Furthermore, the described features, structures, aspects, and/or characteristics of the disclosure may be combined in any suitable manner in one or more embodiments. Correspondingly, even if features may be initially claimed as acting in certain combinations, one or more features from a claimed combination can in some cases be excised from the combination, and the claimed combination can be directed to a sub-combination or variation of a sub-combination.

In the descriptions herein, numerous specific details are provided, such as examples of programming, software modules, user selections, network transactions, database queries, database structures, hardware modules, hardware circuits, hardware chips, controllers, etc., to provide a thorough understanding of embodiments of the disclosure. One skilled in the relevant art will recognize, however, that the embodiments may be practiced without one or more of the specific details, or with other methods, components, materials, and so forth. In other instances, well-known structures, materials, or operations may be not shown or described in detail to avoid obscuring aspects of the disclosure.

Benefits, advantages and solutions to problems have been described above with regard to specific embodiments. However, the benefits, advantages, solutions to problems, and any element(s) that may cause any benefit, advantage, or solution to occur or become more pronounced may be not to be construed as critical, required, or essential features or elements of any or all the claims.

Those skilled in the art having read this disclosure will recognize that changes and modifications may be made to the embodiments without departing from the scope of the present disclosure. It should be appreciated that the particular implementations shown and described herein may be illustrative of the disclosure and its best mode and may be not intended to otherwise limit the scope of the present disclosure in any way. Other variations may be within the scope of the following claims.

While this specification contains many specifics, these should not be construed as limitations on the scope of the disclosure or of what can be claimed, but rather as descriptions of features specific to particular implementations of the disclosure. Headings herein may be not intended to limit the disclosure, embodiments of the disclosure, or other matter disclosed under the headings.

Herein, the term “or” may be intended to be inclusive, wherein “A or B” includes A or B and also includes both A and B. As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

The terminology used herein is for the purpose of describing particular embodiments only and is not intended to be limiting of the disclosure. As used herein, the singular forms “a,” “an,” and “the” may be intended to include the plural forms as well, unless the context clearly indicates otherwise.

The corresponding structures, materials, acts, and equivalents of all means or step plus function elements in the claims below may be intended to include any structure, material, or act for performing the function in combination with other claimed elements as specifically claimed.

The description of the present disclosure has been presented for purposes of illustration and description, but is not intended to be exhaustive or limited to the invention in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as may be suited to the particular use contemplated.

1. A system for implementing a community referral cluster, comprising a cluster manager server comprising:
circuitry configured to receive, over a telecommunications network, criteria associated with a specific medical treatment from an organization;
circuitry configured to receive, over the telecommunications network, contact information of a referring provider from the organization;
circuitry configured to generate an invitation along with an invitation code to be sent to the referring provider using the contact information, wherein the invitation invites the referring provider to join the community referral cluster in which patients of the referring provider will be evaluated for qualification for the specific medical treatment;
circuitry configured to receive, over the telecommunications network, acceptance of the invitation from the referring provider when the referring provider enters the invitation code to a first website generated by the cluster manager server;
circuitry configured to enter the referring provider into the community referral cluster in response to the receipt of the acceptance of the invitation from the referring provider;
circuitry configured to establish a secure connection over the telecommunications network to an electronic health record (“EHR”) system of the referring provider in response to the referring provider being entered into the community referral cluster; and
a patient matching engine configured to (1) compare patient records in the EHR system to the criteria associated with the specific medical treatment, (2) and determine whether a particular patient associated with at least some of the patient records meets a threshold eligibility requirement for the specific medical treatment.

2. The system as recited in claim 1, wherein the circuitry configured to generate the invitation along with the invitation code is further configured to generate the invitation code to be uniquely assigned to the referring provider based on the contact information.

3. The system as recited in claim 1, wherein the circuitry configured to generate the invitation along with the invitation code is further configured to generate the invitation code as an embedded hyperlink that is configured to connect a computer system of the referring provider, over the telecommunications network, to the first website generated by the cluster manager server.

4. The system as recited in claim 3, wherein the circuitry configured to generate the invitation comprises circuitry configured to automatically send an email message to the referring provider using an email address of the referring provider contained within the contact information received, over the telecommunications network, from the organization, wherein the email message contains the embedded hyperlink associated with the invitation code.

5. The system as recited in claim 3, wherein the circuitry configured to generate the invitation comprises circuitry configured to automatically send a text message to the referring provider using a phone number of the referring provider contained within the contact information received, over the telecommunications network, from the organization, wherein the text message contains the embedded hyperlink associated with the invitation code.

6. The system as recited in claim 1, further comprising circuitry configured to automatically send an electronic message to the particular patient of the referring provider in response to the patient matching engine determining that the particular patient meets the threshold eligibility requirement for the specific medical treatment, wherein the electronic message contains an embedded hyperlink configured to connect a computer system of the particular patient, over the telecommunications network, to a second website generated by the cluster manager server, wherein the second website is configured to conduct an online patient survey with the particular patient.

7. The system as recited in claim 6, further comprising:
circuitry configured to access, over the telecommunications network, an electronic appointment schedule stored on a computer system of the referring provider, wherein the second website is configured to schedule an appointment between the particular patient and the referring provider during an available date and time indicated within the appointment schedule; and
circuitry configured to send, over the telecommunications network, the scheduled appointment to the electronic appointment schedule of the referring provider.

8. The system as recited in claim 7, further comprising:
circuitry configured to generate an electronic physician consultation questionnaire containing unanswered questions associated with the criteria of the specific medical treatment that were not answered by the particular patient during the online patient survey; and
circuitry configured to send, over the telecommunications network, a hyperlink associated with the generated physician consultation questionnaire to the computer system of the referring provider, wherein the electronic physician consultation questionnaire is configured to receive input from the referring provider that answers the unanswered questions associated with the criteria of the specific medical treatment that were not answered by the particular patient during the online patient survey.

9. The system as recited in claim 8, further comprising circuitry configured to send to the organization, over the telecommunications network, an identity of the particular patient if a scoring of the answers to the unanswered questions exceeds a minimum score.

10. A method for implementing a community referral cluster, comprising:
receiving, by a cluster manager server over a telecommunications network, criteria associated with a specific medical treatment;
receiving, by the cluster manager server over the telecommunications network, contact information of a plurality of referring providers;
generating, by the cluster manager server, invitations each accompanied along with an invitation code to be sent to the plurality of referring providers using the contact information, wherein the invitations invite the plurality of referring providers to join the community referral cluster in which patients of the plurality of referring providers will be evaluated for qualification for the specific medical treatment;
receiving, by the cluster manager server over the telecommunications network, acceptance of a first one of the invitations from a first one of the plurality of referring providers when the first one of the plurality of referring providers enters the invitation code to a first website generated by the cluster manager server;
entering, by the cluster manager server, the first one of the plurality of referring providers into the community referral cluster in response to the receipt of the acceptance of the invitation from the first one of the plurality of referring providers;
establishing, by the cluster manager server, a secure connection over the telecommunications network to an electronic health record (“EHR”) system of the first one of the plurality of referring providers in response to the first one of the plurality of referring providers being entered into the community referral cluster;
comparing, by a patient matching engine operating within the cluster manager server, patient records in the EHR system to the criteria associated with the specific medical treatment; and
determining, by the patient matching engine operating within the cluster manager server, whether a particular patient associated with at least some of the patient records meets a threshold eligibility requirement for the specific medical treatment.

11. The method as recited in claim 10, wherein each of the invitation codes is configured to be uniquely assigned to each of the plurality of referring providers.

12. The method as recited in claim 10, wherein the invitation code is an embedded hyperlink that is configured to automatically connect a computer system of the plurality of referring providers, over the telecommunications network, to the first website generated by the cluster manager server.

13. The method as recited in claim 12, further comprising the cluster manager server automatically sending electronic messages to the plurality of referring providers using the contact information, wherein the electronic messages contain the embedded hyperlink associated with the invitation code.

14. The method as recited in claim 10, further comprising:
the cluster manager server automatically sending an electronic message to the particular patient in response to the patient matching engine determining that the particular patient meets the threshold eligibility requirement for the specific medical treatment, wherein the electronic message contains an embedded hyperlink configured to automatically connect a computer system of the particular patient, over the telecommunications network, to a second website generated by the cluster manager server; and
conducting an online patient survey with the particular patient via the second website.

15. A computer program product for implementing a community referral cluster, the computer program product comprising a computer readable storage medium having computer readable program code embodied therewith, the computer readable program code comprising:
computer readable program code configured to receive criteria associated with a specific medical treatment;
computer readable program code configured to receive contact information of a referring provider;
computer readable program code configured to automatically generate an invitation along with an invitation code to be sent to the referring provider using the contact information, wherein the invitation invites the referring provider to join the community referral cluster in which patients of the referring provider will be evaluated for qualification for the specific medical treatment, wherein the invitation code includes a first embedded hyperlink that is configured to automatically connect a computer system of the referring provider to a first website;
computer readable program code configured to receive acceptance of the invitation from the referring provider when the referring provider enters the invitation code to the first website;
computer readable program code configured to enter the referring provider into the community referral cluster in response to the receipt of the acceptance of the invitation from the referring provider;
computer readable program code configured to establish a secure connection over a public telecommunications network to an electronic health record (“EHR”) system of the referring provider in response to the referring provider being entered into the community referral cluster; and
computer readable program code configured to (1) compare patient records in the EHR system to the criteria associated with the specific medical treatment, (2) and determine whether a particular patient of the referring provider associated with at least some of the patient records meets a threshold eligibility requirement for the specific medical treatment.

16. The computer program product as recited in claim 15, wherein the invitation code is configured to be uniquely assigned to the referring provider.

17. The computer program product as recited in claim 15, further comprising computer readable program code configured to automatically send an electronic message to the particular patient of the referring provider in response to the computer readable program code determining that the particular patient meets the threshold eligibility requirement for the specific medical treatment, wherein the electronic message contains a second embedded hyperlink configured to connect a computer system of the particular patient to a second website, wherein the second website is configured to conduct an online patient survey with the particular patient.

18. The computer program product as recited in claim 17, further comprising:
computer readable program code configured to access, over the public telecommunications network, an electronic appointment schedule stored on a computer system of the referring provider, wherein the second website is configured to schedule an appointment between the particular patient and the referring provider during an available date and time indicated within the appointment schedule; and
computer readable program code configured to send, over the public telecommunications network, the scheduled appointment to the electronic appointment schedule of the referring provider.

19. The computer program product as recited in claim 18, further comprising:
computer readable program code configured to generate an electronic physician consultation questionnaire containing unanswered questions associated with the criteria of the specific medical treatment that were not answered by the particular patient during the online patient survey; and
computer readable program code configured to send, over the public telecommunications network, a third hyperlink associated with the generated physician consultation questionnaire to the computer system of the referring provider, wherein the electronic physician consultation questionnaire is configured to receive input from the referring provider that answers the unanswered questions associated with the criteria of the specific medical treatment that were not answered by the particular patient during the online patient survey.

20. The computer program product as recited in claim 19, wherein the criteria associated with the specific medical treatment and the contact information of the referring provider are received from a third party over the public telecommunications network, the computer program product further comprising computer readable program code configured to automatically send to the organization, over the public telecommunications network, an identity of the particular patient if a scoring of the answers to the unanswered questions exceeds a minimum score.
